(19) United States
(12) Patent Application Publication
(10) Pub. No.: US 2007/0282594 A1
(43) Pub. Date: Dec. 6, 2007

(54) Machine translation in natural language application development

(75) Inventor: Michelle S. Spina, Winchester, MA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/445,798

(22) Filed: Jun. 2, 2006

(51) Int. Cl. G06F 17/27

(52) U.S. Cl. 704/9

(57) ABSTRACT

Machine translation architecture for natural language application development. The architecture facilitates automatic translation of developed training datasets into a full set of desired target languages. Additionally, select ones of the training data can be tagged and utilized as a test dataset for testing performance. Accordingly, only a single input dataset is utilized, and from which all other datasets are created via machine translation. The architecture includes a first dataset of natural language data in a first human language which can be automatically translated via a machine translation component into at least a second dataset in a second human language. In one aspect, the data of the input dataset is then replaced by the translated data output from the machine translation engine to form the final dataset in a different language.

### BACKGROUND

In the past, individuals who interfaced with software systems had some knowledge of artificial languages (e.g., programming languages) in the form of commands and input text needed to obtain the desired information. However, software is playing a more prominent role in the day-to-day interactions between individuals and systems (e.g., retail systems such as reservation systems, call routing systems, word processing programs, and e-mail programs). Accordingly, in order to make this software more functional and usable, the demand is for software that can receive and process natural language, that is, language that the average person tends to speak. Moreover, as these natural language applications become more commonplace, there is an increasing need for support of these systems across a wide range of languages in order to address the global market.

However, it can be difficult to obtain and properly process the large volume of data that is required to adequately train and test these types of applications in each of the desired target languages. For instance, hundreds to potentially thousands of example sentences are required to adequately train speech-enabled applications that utilize concept recognition technology. This type of technology not only recognizes what the user is saying (e.g., a textual representation or transcription of what was said to the system is produced using automatic speech recognition), but also classifies what was said into one of a set of predefined concepts.

For each concept to be recognized by the system, a large collection of example sentences is required to characterize the many ways callers (in the context of telephone systems) can express the concept. A statistical model is then trained from this collection of tagged data. This model is then used to classify an incoming and potentially previously unseen example into one of the predefined concepts. For example, when considering a natural language enabled retail application, customer inquiries can be classified into one of the following five possible concepts: get store hours, locate the nearest store, get driving directions, check inventory availability, and inquire about order status. For each of these five concepts, the application developer must provide a large collection of representative examples from which the model is trained.

The more data that is available to train these types of models, the more robust, and therefore, more accurate, the models will be when deployed. Obtaining data suitable for the development of these systems, both to ensure that the technology meets the defined functional requirements and for use in actual application development, can be a costly investment when considering a single supported language. Suitable data must be collected or generated, and organized into the appropriate classes for system training. Similarly, test data must be collected and organized so that system performance can be measured. To ensure that the testing yields statistically significant results, a large test dataset is required. When multiple languages need to be supported, which is oftentimes the case in a global marketplace, the degree of difficulty of obtaining this data increases substantially as developers are often required to test their systems in languages unfamiliar to them.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed architecture utilizes machine translation technology in the development of natural language applications to automatically translate developed datasets into a full set of desired target languages. In the context of application development, machine translation can be employed in an authoring tool (e.g., speech) for automation of an otherwise costly and time-consuming process of translating from one human language to another. This reduces the effort required to develop multiple training and test datasets (one for each different target language) into the effort required to develop a single dataset in a single language.

The disclosed architecture facilitates functional testing of the underlying natural language technology being developed across the target languages, exposing any language-specific idiosyncrasies that may exist. In addition, the innovation enables rapid development of applications across the target languages without the requirement of costly and specific language expertise.

In one implementation, the disclosed architecture combines machine translation in a software application development authoring tool to generate data for a variety of target human languages based on development of a single starting dataset for use in, for example, natural language technology development and application building.

Moreover, the disclosed architecture is beneficial for both speech and text input based systems, and is equally applicable to both types of individual systems.

The subject innovation can be used not only for training and testing of the concept recognition technology component that provides the mapping from text representation to underlying meaning, but also for the training of statistical models used by automatic speech recognition engines, which also require large collections of data for training and testing.

Accordingly, the architecture disclosed and claimed herein, in one implementation thereof, comprises a first dataset of natural language data in a first human language which can be automatically translated via a machine translation component into at least a second dataset in a second human language. The data of the input dataset can then be replaced by the translated data output from the machine translation engine to form the final dataset in a different human language.

In yet another implementation thereof, a machine learning and reasoning is provided that employs a probabilistic and/or statistical-based analysis to prognose or infer an action that a user desires to be automatically performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates generation of multi-language natural language datasets.

FIG. 2 illustrates a methodology of generating multi-language natural language models for application development.

FIG. 3 illustrates a more detailed methodology of machine translation processing for natural language applications.

FIG. 4 illustrates a block diagram of an authoring tool system that provides machine translation for application development.

FIG. 5 illustrates a flow diagram of a methodology of tagging training data for testing purposes.

FIG. 6 illustrates a methodology of facilitating application development by importing data in accordance with the disclosed innovation.

FIG. 7 illustrates a diagram of concept tree processing.

FIG. 8 illustrates a flow diagram of a methodology of node-level processing.

FIG. 9 illustrates a methodology of performing container-level translation.

FIG. 10 illustrates an alternative system that employs a machine learning and reasoning component which facilitates automating one or more features in accordance with the subject innovation.

FIG. 11 illustrates a methodology of learning and reasoning aspects of the architecture for modification and/or automation thereof.

FIG. 12 illustrates a flow diagram of a methodology of blending at least two different languages into a single training dataset.

FIG. 13 illustrates a block diagram of an alternative implementation of an application development system in accordance with validation.

FIG. 14 illustrates a block diagram of a computer operable to execute the disclosed machine translation application development architecture.

FIG. 15 illustrates a schematic block diagram of an exemplary computing environment operable to support authoring and machine translation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

The disclosed architecture employs machine translation technology, at least in terms of application development, to automatically translate a single developed dataset into a full set of desired target languages. Machine translation automates the otherwise costly and time-consuming process of translating from one human language to another. This reduces the effort required to develop multiple training and test sets, one for each target language, into the effort required to develop datasets in a single language. The disclosed architecture facilitates functional testing of the underlying natural language technology being developed across all target languages, exposing any language-specific idiosyncrasies that may exist. Although described in the context of natural language processing (NLP), the disclosed architecture also finds application in automatic speech recognition (ASR) systems and text translation systems.

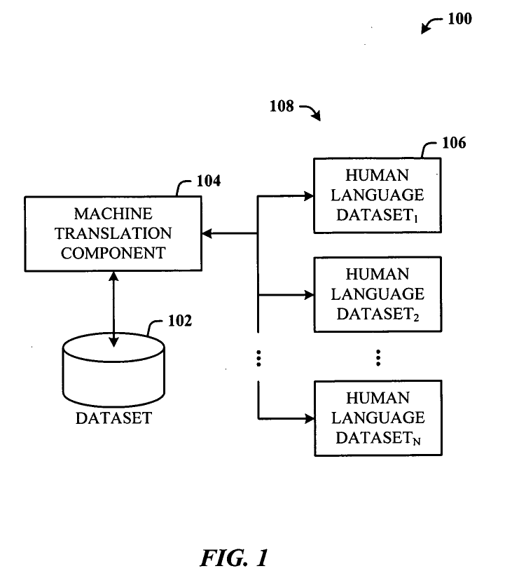

Referring initially to the drawings, FIG. 1 illustrates a computer-implemented system 100 that facilitates generation of multi-language natural language datasets for in a software application development and building environment. The system 100 comprises a first dataset 102 of natural language data in a first human language, and a machine translation component 104 that automatically translates the first dataset 102 into at least a second dataset 106 in a second human language (that is different from the language of the first dataset 102). The second dataset 106 can be one of many different human language datasets 108 (denoted HUMAN LANGUAGE DATASET₁, . . . ,HUMAN LANGUAGE DATASET_{N}, where N is a positive integer) of different corresponding human languages. Moreover, in that the first dataset 102 is developed in a natural language format, the output datasets 108 are machine translated into corresponding natural language formats suitable for understanding in the given output language (e.g., Spanish, German, North American German, Russian, . . . ).

It is to be understood that the disclosed machine translation architecture can include and/or access components that facilitate or provide some or all of at least the following example data and processes that facilitate understanding humans via natural language processing and/or speech recognition: information retrieval, extraction and inferencing related to phonetics and phonology (how words are pronounced in colloquial speech), parsing, morphological analysis (about the shape and behavior of words in context), lexical semantics (the meanings of the component words), lexical ambiguity, syntactical analysis (about the ordering and grouping of words), pragmatics (use of polite and indirect language), language dictionaries, statistical rules, linguistic rules, lexical lookup methods, semantics processing, compositional semantics (knowledge of the how component words combine to form larger meanings), speech segmentation, text segmentation, word sense disambiguation, contextual processing, temporal and/or spatial reasoning, speech acts or plans (for dealing with sentences or phrases that do not mean what is literally expressed), discourse conventions, and imperfect or irregular input (for dealing with foreign or regional accents, vocal impediments, and typing or grammatical errors). Moreover, it is within contemplation of the subject architecture that statistical natural language processing can be utilized that employs stochastic, probabilistic and statistical methods to resolve some of the more complex processes referred to above, as well as pattern-based machine translation technologies.

Additionally, the machine translation component 104 is not limited by the type of translation engine, and thus, can utilize engines that are based on a direct (or transformer) architectures, or indirect (or linguistic knowledge) architectures, for example.

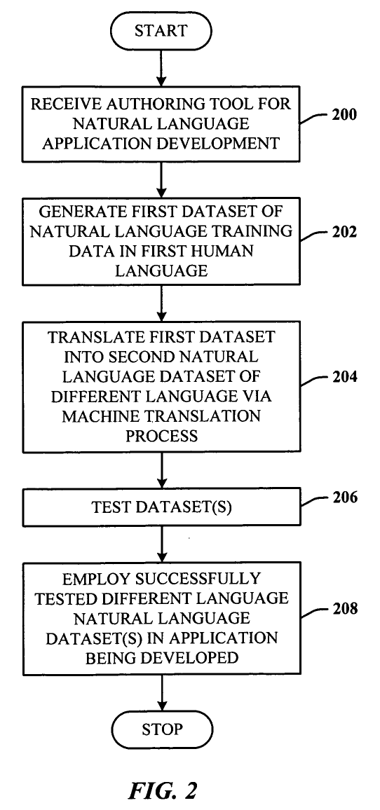

FIG. 2 illustrates a methodology of generating multi-language natural language models for software application development. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, an authoring tool is received that is utilized for application development. The authoring tool can be a standalone program that allows a user to write program code. Alternatively, the authoring tool can be a considered a suite of programs as associated with an integrated development environment and/or an application development environment that includes a set of programs which can be run from a single user interface, such as a programming language that also includes a text editor, compiler and debugger, for example. In one example implementation, the authoring tool user interface facilitates use of a grammar builder program via which the author can describe responses to prompts which the application being developed is expected to receive and process. The responses can be presented by a user as utterances and/or text inputs. At 202, a first dataset of natural language training data is generated in a first human language. At 204, the first dataset is machine translated into a second natural language dataset of a different human language. At 206, the second dataset is tested at least for performance. If the tested dataset successfully meets the desired test criteria, the second dataset is employed in the application being developed, as indicated at 208.

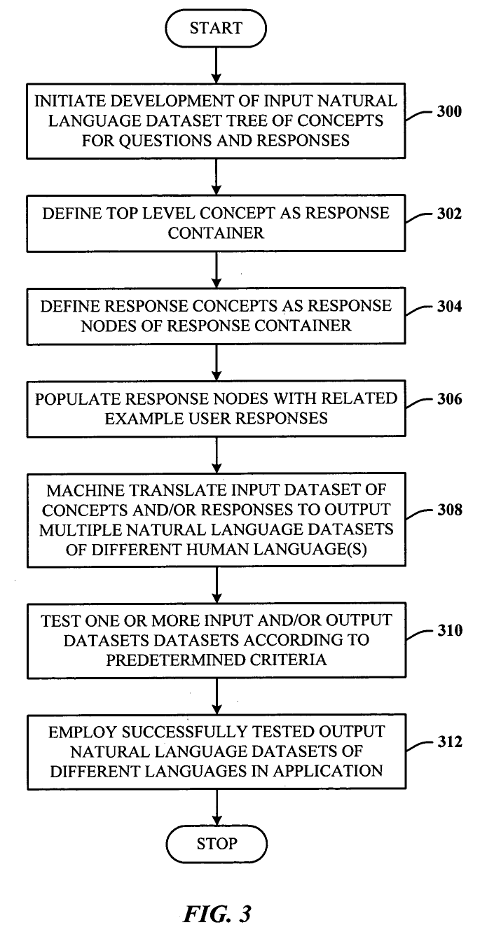

Referring now to FIG. 3, there is illustrated a more detailed methodology of machine translation processing for natural language applications. At 300, development of an input dataset concept tree is initiated. The dataset tree includes natural language concepts for questions and responses. In one implementation, the input dataset is in the English language, while the output datasets are in languages other than English. In another implementation, the input language dataset is other than English, and the output datasets include a natural language dataset that is in English.

At 302, a top level concept (or rule) is defined and associated with a response container. Here, the author can describe responses to a prompt which the application is expected to handle. The author (or application developer) typically defines the top level rule to be associated with a particular dialog element, or “question answer,” in the application.

A response container can contain one or more response nodes, which response nodes define the individual high level concepts that are handled by the application. Accordingly, at 304, response concepts are defined for underlying response nodes of the tree. For example, consider a retail application example having a top level rule of “How May I Help You?” The response container could hold the following five response nodes: 1) “Get Store Hours”, 2) “Locate Nearest Store”, 3) “Get Driving Directions”, 4) “Check Inventory Availability”, and 5) “Order Status Inquiry”.

At 306, after defining the response nodes within the response container, the developer populates each of the nodes with a collection of example sentences (or utterances) that represent the many ways a user interacting with the system could articulate the concept being conveyed. For example, the “Get Store Hours” node can contain utterances similar to “How late are you open today?”, “What are your store hours?”, “What time do you open?”, “Are you open on Sunday?”, and so on.

After each of the response containers and their underlying response nodes have been fully defined, that is, when all of the response nodes for each response container defined in the application have been populated with all of the example utterances the developer wishes to include, the developer can initiate machine translation of the container(s) and associated nodes (e.g., example utterances) to output a natural language dataset in a different human language, as indicated at 308.

In another implementation, the machine translation process facilitates output of multiple natural language datasets each in its own human language.

At 310, testing can be performed on one or more of the output datasets in accordance with predetermined testing criteria. The criteria can be employed to provide a success or failure indication as to the quality of the output dataset in processing test data. In another implementation, metrics are employed that indicate a degree of success or failure, thereby providing a more accurate representation of the quality of the dataset. If successful, the language dataset can be employed in the desired application, as indicated at 312.

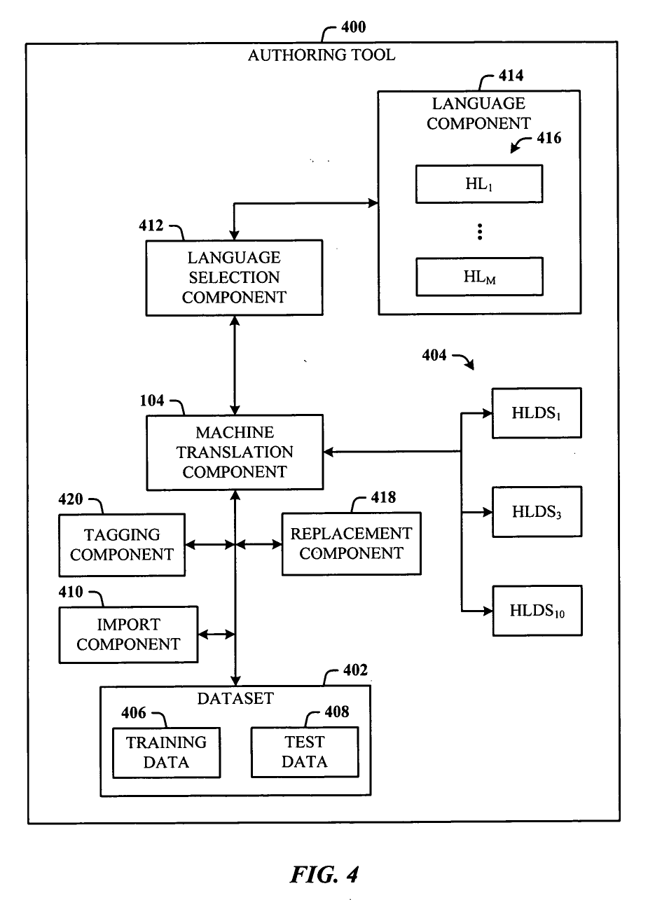

FIG. 4 illustrates a block diagram of an authoring tool system 400 that provides machine translation for application development. The system 400 can include the machine translation component 104 for translating an input dataset 402 of a first language into one or more output datasets 404 of different languages. The dataset 402 can include natural language training data 406 and/or natural language test data 408.

In one implementation, the input dataset 402 is intended to be a “master” dataset from which all other output datasets will be created by machine translation. In another implementation, it is to be understood that the dataset 402 can represent multiple different input datasets each of which includes training data, and optionally, test data, and from which the desired output datasets are generated. For example, it is to be appreciated that a first dataset may, over time, prove to be a better “fit” for machine translation into the many dialects of the Chinese language, rather than a second input dataset, which proves to be a better “fit” for Middle Eastern dialects. Accordingly, these different input datasets can be stored and automatically retrieved based on the desired output languages. Thereafter, machine translation can be utilized to more effectively provide the desired output natural language datasets.

As indicated supra, the developer can manually enter information, expressions, etc., into the input dataset 402. Alternatively, or in combination therewith, an import component 410 facilitates importing the desired information, expressions, utterances, etc., into the system 400 from other files and/or file formats, for more expedient development. This capability significantly reduces the time the developer would need to take to re-enter the information manually into the response containers and response nodes, for example. The import component 410 can be a software capability provided as program menu option for importing (or exporting) files and/or other types of data, which capability can be commonly found in conventional software applications. Alternatively, a separate program can be provided that receives incompatible formats (e.g., proprietary formats) and converts this information into a format suitable for importation and processing by the authoring tool.

The system 400 can employ a language selection component 412 that interfaces the machine translation component 104 to a language component 414 for selecting one or more human languages 416 (denoted HL₁, . . . , HL_{M}, where M is a positive integer) into which the input dataset 402 will be translated. The languages 416 can be in the form of language models that can be readily updated as needed. Selection of the languages 416 can be via a menuing system of a user interface, for example.

Once the languages 416 are selected, the machine translation component 104 translates the completed input dataset(s) 402 into the corresponding output human language datasets 404 (denoted in this example as three datasets HLDS₁, HLDS₃, and HLDS₁₀ that correspond to three selected human languages HL₁, HL₃, and HL₁₀ of the language component 414).

A replacement component 418 facilitates insertion of the machine translated natural language expressions (or data) back into the corresponding locations of the response container tree(s) to arrive at the final output natural language dataset.

A tagging component 420 facilitates tagging of selected training data 406 for generating the test data 408. Although represented as a block separate from the training data 406, the test data 408 represents training data that has been automatically selected and grouped for testing purposes. As a separate block, the test data 408 can be a copy of the tagged training data which is then set aside for testing and analysis purposes.

Although the machine translation engine and related components have been described in combination with a development tool, it is to be understood that the engine/components can be a standalone application that interfaces to the tool 400 to provide the disclosed functionality.

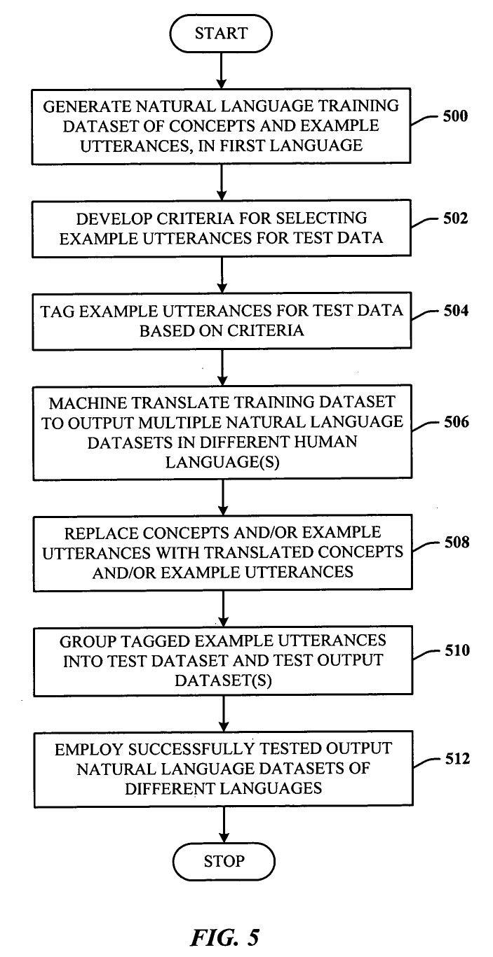

FIG. 5 illustrates a flow diagram of a methodology of tagging training data for testing purposes. At 500, a natural language training dataset of at least concepts and example utterances is generated in a first language. At 502, criteria for data tagging (e.g., example utterance tagging) is developed. At 504, example utterances are tagged for testing purposes based on the criteria. At 506, the training dataset is machine translated to output multiple natural language datasets in different human languages. At 508, the example utterances in the input dataset are replaced with the translated utterances. At 510, tagged example utterances are grouped into a test dataset and utilized for testing the output datasets. At 512, each successfully tested output dataset is employed.

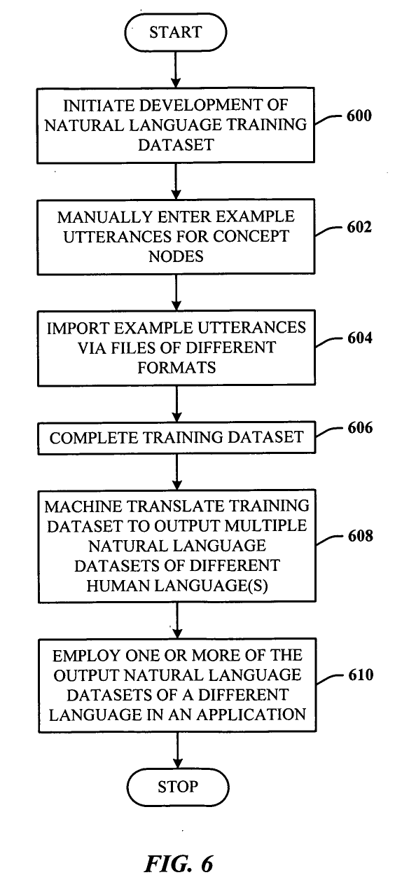

FIG. 6 illustrates a methodology of facilitating application development by importing data in accordance with the disclosed innovation. At 600, development of a natural language training dataset is initiated. At 602, some or all of the example utterances for concept nodes are manually entered. At 604, optionally, alternatively, or in combination with manual entry, node information can be imported into the authoring tool for insertion into the appropriate locations of the training dataset. Manual entries that match imported entries can be overwritten, or retained, as desired. For example, consider a call center scenario where call interactions between customers and the call center have been recorded and transcribed. Thus, questions, responses, and selections can be known for a variety of implementations. Accordingly, portions or all of this information can be transcribed and imported into the tool. At 606, the training dataset is completed. At 608, the training dataset is then machine translated into multiple output natural language datasets of different human languages. At 610, one or more of the output datasets is then employed in the application.

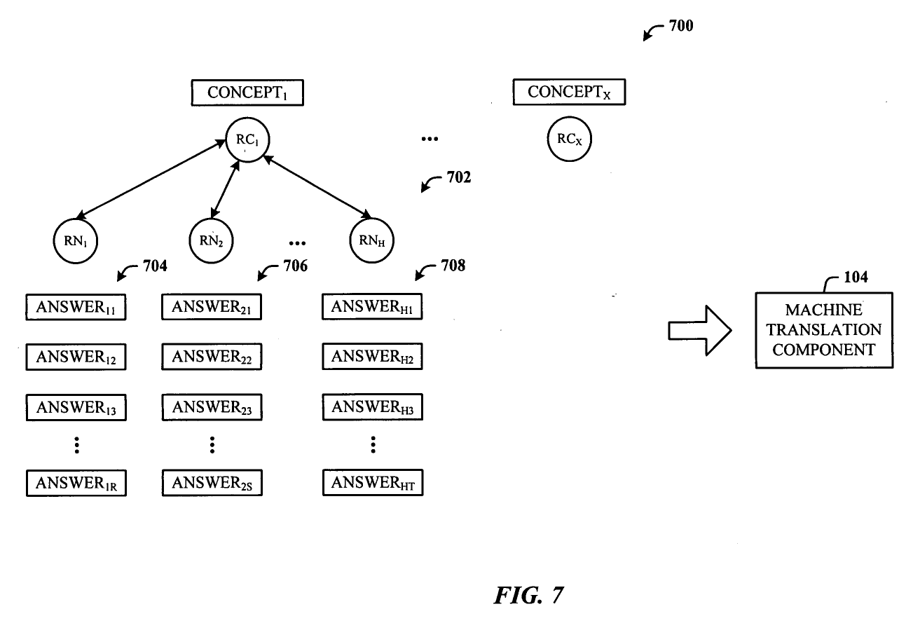

FIG. 7 illustrates a diagram of concept tree processing. Development can begin by defining one or more top-level rules 700 (or response containers, denoted RC₁, . . . ,RC_{X}, where X is a positive integer). The first response container RC₁ has a top-level concept (denoted as CONCEPT₁). Revisiting the retail example, the top-level rule can be a question of “How May I Help You?” The first response container RC₁ can hold the following respective response nodes 702 (denoted RN₁, RN₂, . . . ,RN_{H}, where H is a positive integer) of “Get Store Hours”, “Locate Nearest Store”, “Get Driving Directions”, “Check Inventory Availability”, and “Order Status Inquiry”. The first response node RN₁ of “Get Store Hours” can be populated (manually and/or automatically, and by importation) with example utterances 704 (denoted ANSWER₁₁, . . . ,ANSWER_{1R}, where R is a positive integer). Similarly, the second response node RN₂ of “Locate Nearest Store” can be populated (manually and/or automatically by importation) with example utterances 706 (denoted ANSWER₂₁, . . . ,ANSWER_{2S}, where S is a positive integer). Finally, the H^{th} response node RN_{H} of, for example, “Order Status Inquiry”, can be populated (manually and/or automatically by importation) with example utterances 708 (denoted ANSWER_{H1}, . . . ,ANSWER_{HT}, where T is a positive integer).

The developer can be selective about which information to translate in a container tree. In other words, it is not a requirement that the whole container tree be translated. For example, translation via the machine translation component 104 can be performed at the response node level by selecting one or more of the response nodes 702, for example, the first response node RN₁ and associated example utterances 704. Response node level translation can be performed by selecting a machine translation function for the desired node, followed by selecting the desired target language(s). In one implementation, selection of the desired target language automatically triggers the machine translation process for the entire tree(s) or just the nodes.

Alternatively, selection of the first response container RC₁ can trigger the machine translation process for all of the example utterances (704, 706 and 708) in the corresponding response nodes 702 contained therein. The individual example utterances can then be replaced by their machine translated substitutes.

Thereafter, the authoring tool can utilize these translated examples as an input to train models for ASR systems and/or NLP systems, for example. Additionally, as indicated herein, one or more example utterances within a response node can be tagged as being slated for testing purposes, which enables the use of the disclosed novel technology for developing both training and testing data for the desired systems.

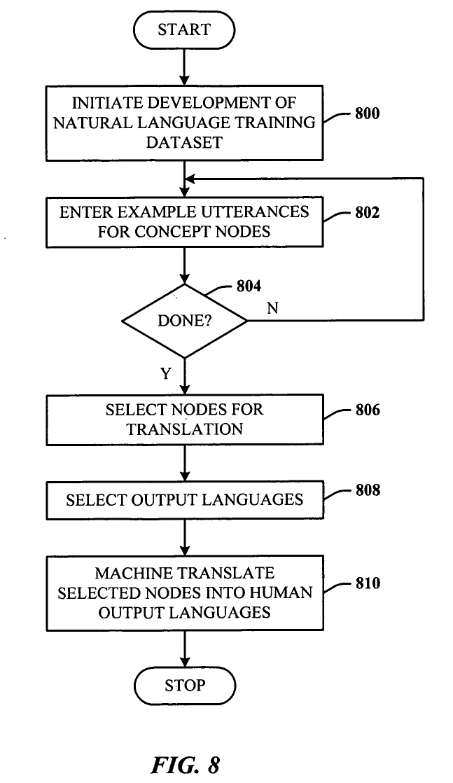

FIG. 8 illustrates a flow diagram of a methodology of node-level processing. At 800, development of a natural language training dataset is initiated. At 802, example utterances (and/or other concept data) are entered for concept nodes. At 804, a check is performed to determine if entry of the example utterances (and/or other concept data) has completed. If not, flow is back to 802 to continue insertion of the example utterances. If the insertion process is done, flow is from 804 to 806 where nodes are selected for translation. At 808, one or more output languages are selected. At 810, the selected nodes are machine translated into human language outputs. As indicate supra, selection of the output language(s) can form the basis for automatically initiating machine translation of the selected nodes.

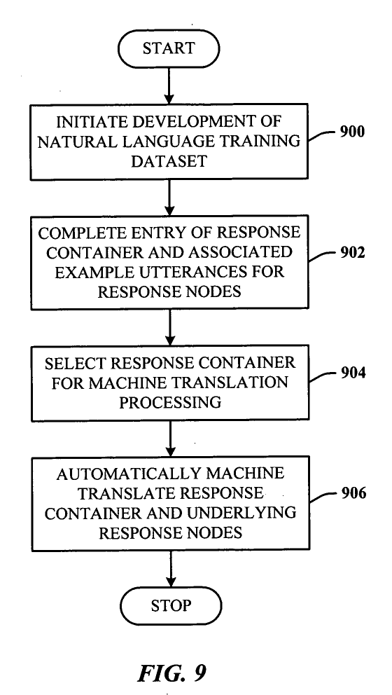

FIG. 9 illustrates a methodology of performing container-level translation. At 900, development of a natural language training dataset is initiated. At 902, the developer completes entry of response container information and associated response node information and/or example utterances. At 904, the response container is selected for machine translation. This selection process can act as a trigger for automatically initiating machine translation of the entire container (and its underlying response nodes and example utterances), as indicated at 906. It is to be understood that machine translation can be initiated for only the concept information and not the example utterances, as well.

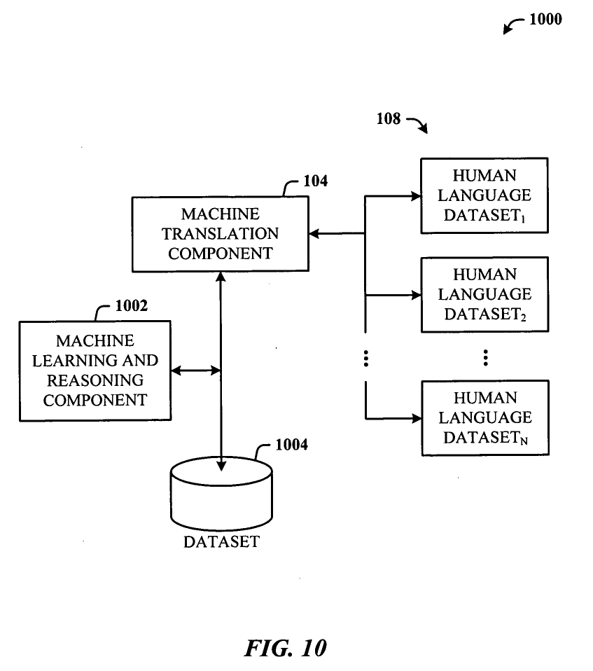

FIG. 10 illustrates an alternative system 1000 that employs a machine learning and reasoning (MLR) component 1002 which facilitates automating one or more features. Here, the MLR component 1002 interfaces to the machine translation component 104 and the one or more input datasets 1004 to learn and reason about interactions between the translation component 104 and the one or more datasets 1004, and about the languages datasets 108 into which the training data is translated. The invention (e.g., in connection with selection) can employ various MLR-based schemes for carrying out various aspects thereof. For example, a process for determining which example utterances to select can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

In one implementation, the MLR component 1002 can learn and reason about which of multiple input datasets to use for translation processing. For example, as indicated supra, the developer can define many different datasets over time, some of which operate to translate better for the desired output languages. In operation, when the developer selects the output language(s), the MLR component 1002 can recommend that a specific input dataset be employed, since, as learned in the past, this dataset shows a higher rate of success for translation than another. Although the disclosed architecture describes use of a single input dataset for translation into the many output languages, it is to be appreciated that based on testing, an input dataset can be computed to be less than optimal for translation into the desired output languages. However, this dataset may prove to be a better dataset for translation into other languages than currently desired. Accordingly, the developer can save these many different versions of input datasets for later use. Based on this swapping in and out of input datasets to arrive at the optimal output languages, the MLR component 1002 can learn and reason about this, thereafter recommending one input dataset over another, for example, based on the desired output languages.

In another implementation, the MLR component 1002 can perform cost/benefit analysis based on the type of machine translation engine utilized for the input dataset and desired output dataset languages, and therefrom, suggest that another type of engine may provide an improvement on the translation process.

In yet another implementation, this type of translation management can be reduced to a lower level, wherein the MLR component 1002 operates to learn and reason about which of the data (at the node level, for example) in the training dataset to tag for utilization as the testing dataset.

These are only but a few examples of the flexibility that can be employed by the MLR component 1002, and are not to be construed as limiting in any way. For example, in still another implementation, learning and reasoning can be applied to determining the number and type of example utterances to generate for a given response node, the number of containers for the application, and so on. The number of example utterances required for translation into a Chinese dialect may be fewer than the number required for translation into English, for example.

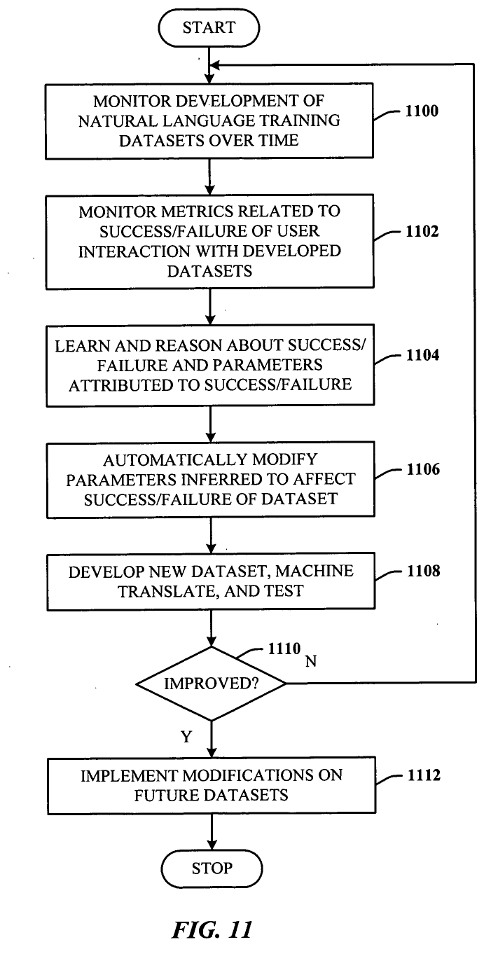

FIG. 11 illustrates a methodology of learning and reasoning about aspects of the architecture for modification and/or automation thereof. At 1100, the system monitors at least development of natural language training datasets over time. At 1102, metrics can also be monitored related to success/failure of user interaction with the developed datasets, as well as performance parameters. At 1104, the MLR component learns and reasons about at least success/failure and parameters attributed to the success/failure of the dataset to meet specific criteria. This can be related to performance, for example. At 1106, based on what has been learned and reasoned, the MLR component is suitably robust and connected to modify (or update) at least parameters inferred to affect success/failure of a dataset. This modification (or update) process can also include parameters related to performance, when processing test datasets. At 1108, a new dataset is developed, machine translated, and tested. At 1110, the system processes according to the now modified (or updated) parameters and determines against predetermined criteria if the outcome is an improvement. If not, flow can loop back to 1100 to continue monitoring development, and repeat the process until an improvement has been achieved. However, if an improvement has been achieved, flow is from 1110 to 1112, to implement the modifications (or updates).

Accordingly, the MLR component facilitates at least maintaining a system according to the desired metrics. Moreover, it can be appreciated that in many cases, the system can be improved upon based on changes that occur in the underlying data, and other system parameters.

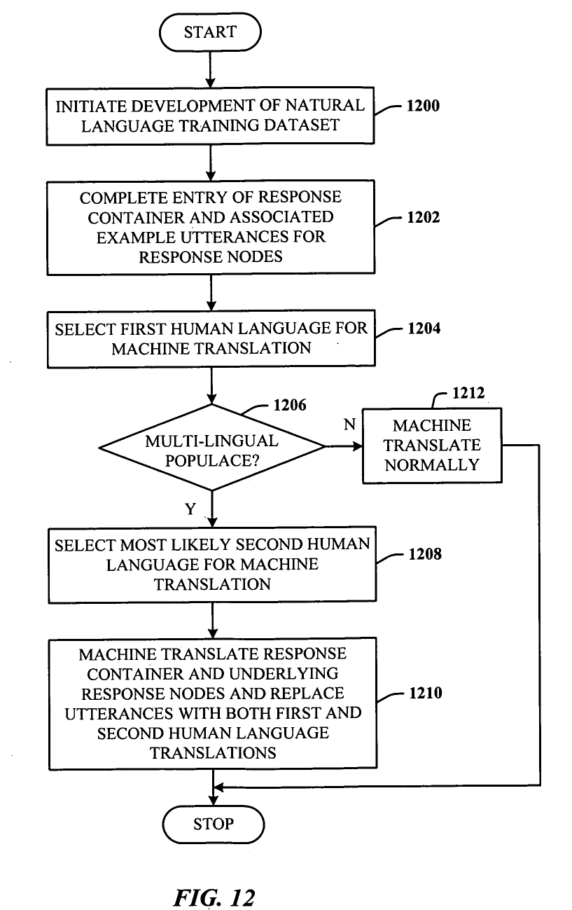

FIG. 12 illustrates a flow diagram of a methodology of blending at least two different languages into a single training dataset. This implementation finds application where the populace, typically, is multi-lingual. For example, in Europe, most people speak two or more languages fluently. In other words, Germans can speak French with equal ability. Thus, rather than retrieve and process two separate language datasets when receiving input, a single dataset can be developed that includes the two most popularly spoken languages of the region where the application is most likely going to be marketed or utilized.

At 1200, development of a natural language training dataset is initiated. At 1202, entry of the response container and associated example utterances for the response nodes, is completed, in preparation for translation. At 1204, the developer selects the first language for machine translation. The system can then check if the first selected language is normally associated with a multi-lingual populace and/or if the application being developed is slated for use in an area of multi-lingual users, as indicated at 1206. If so, at 1208, the developer can then manually select a second language in which the populace is normally fluent for that area. Alternatively, the system presents lists of languages from which to select the most likely second language for this dataset. At 1210, the system machine translates both the first and second languages for the concept tree(s), and inserts the translated data back into the tree(s) at the appropriate places. Thus, a single example utterance will be replaced with two translated utterances: one in the first language, and the other in the second language. If is determined not to be a multilingual populace, flow is from 1206 to 1212, to machine translate as would be performed normally.

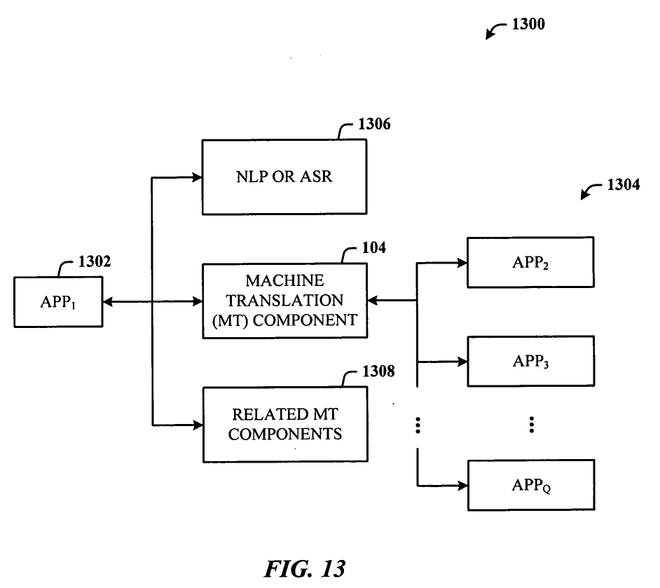

FIG. 13 illustrates a block diagram of an alternative implementation of an application development system 1300 that can be utilized for testing. The system 1300 can be employed as a testing tool for validation across language sets. For example, a completed application 1302 can be re-processed through the machine translation component 104 using test datasets to output the desired language applications 1304 (denoted APP₂, . . . ,APP_{Q}, where Q is a positive integer). As indicated supra, select ones of the example utterances, for example, can be tagged for testing purposes. However, it is not a requirement that training and testing go hand-in-hand, as is described herein. Accordingly, it is to be understood that testing can occur as the training data is being developed, and/or as a separate repeated process at a subsequent time, and for any purposes. The system 1300 finds relevance to speech recognition systems (or engines) and natural language processing systems 1306, for example. In support of such operations, the machine translation component 104 interfaces to other related components 1308, which can include components described hereinabove in FIG. 4.

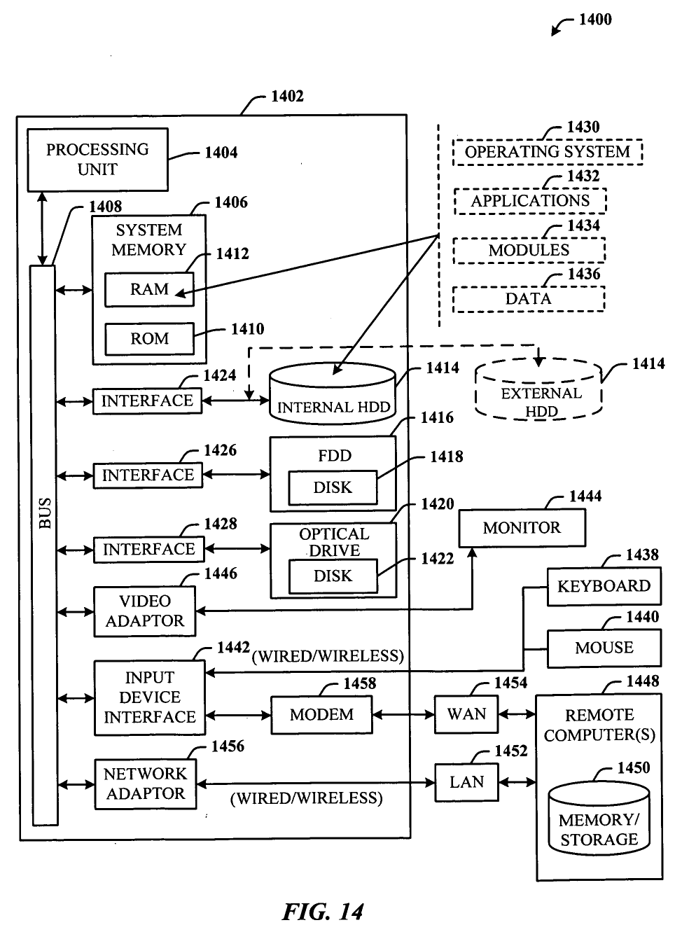

Referring now to FIG. 14, there is illustrated a block diagram of a computer operable to execute the disclosed machine translation application development architecture. In order to provide additional context for various aspects thereof, FIG. 14 and the following discussion are intended to provide a brief, general description of a suitable computing environment 1400 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 14, the exemplary environment 1400 for implementing various aspects includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA) on which the various authoring tool and machine translation components can be stored, which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1412, including an operating system 1430, one or more application programs 1432 (e.g., the authoring tool, machine translation engine, . . . ), other program modules 1434 and program data 1436. All or portions of the operating system, applications, modules, and/or data can also be cached in the RAM 1412. It is to be appreciated that the innovation can be implemented with various commercially available operating systems or combinations of operating systems.

A user can enter commands and information into the computer 1402 through one or more wired/wireless input devices, for example, a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, for example, a wide area network (WAN) 1454. Such LAN and WAN networking environments are commonplace in offices and companies, and facilitate enterprise-wide computer networks, such as intranets, all of which may connect to a global communications network, for example, the Internet.

When used in a LAN networking environment, the computer 1402 is connected to the local network 1452 through a wired and/or wireless communication network interface or adapter 1456. The adaptor 1456 may facilitate wired or wireless communication to the LAN 1452, which may also include a wireless access point disposed thereon for communicating with the wireless adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

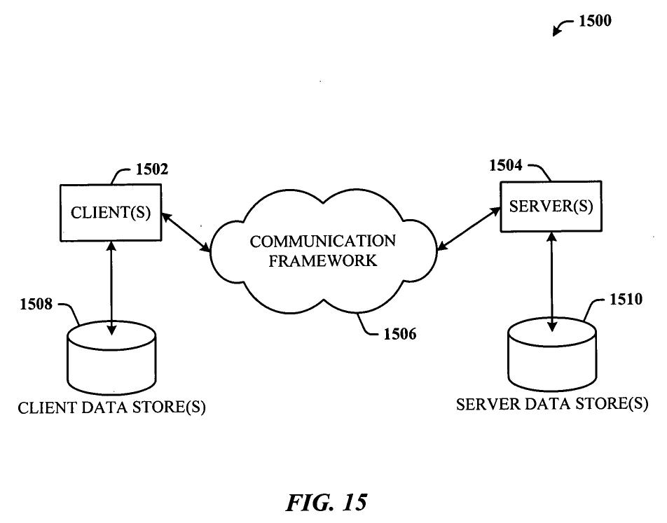

Referring now to FIG. 15, there is illustrated a schematic block diagram of an exemplary computing environment 1500 operable to support authoring and machine translation. The system 1500 includes one or more client(s) 1502. The client(s) 1502 can be hardware and/or software (e.g., threads, processes, computing devices). The client(s) 1502 can house cookie(s) and/or associated contextual information by employing the subject innovation, for example.

The system 1500 also includes one or more server(s) 1504. The server(s) 1504 can also be hardware and/or software (e.g., threads, processes, computing devices). The servers 1504 can house threads to perform transformations by employing the invention, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates generation of multi-language natural language datasets in a natural language application development environment, comprising:
in the development environment, a first dataset of natural language data in a first human language; and
a machine translation component of the development environment that automatically translates the first dataset into at least a second dataset in a second human language.

2. The system of claim 1, wherein the first dataset includes at least one of natural language training data or natural language test data.

3. The system of claim 1, further comprising a tagging component that tags training data of the first dataset for utilization as test data in testing the second dataset.

4. The system of claim 1, wherein the first and second datasets include expressions understandable as natural language expressions.

5. The system of claim 1, further comprising an automatic speech recognition engine having a statistical model that is trained on the first dataset.

6. The system of claim 1, further comprising a selection component that facilitates selection of two or more human languages of a language component into which the first dataset will be translated.

7. The system of claim 1, wherein the machine translation component automatically translates the first dataset into the second human language and at least one other different human language.

8. The system of claim 1, wherein the machine translation component facilitates translation of at least one of speech input or text input.

9. The system of claim 1, further comprising an import component that facilitates importation of content information via different file formats.

10. The system of claim 1, further comprising a replacement component that facilitates replacement of content information of the first dataset with translated data.

11. The system of claim 1, further comprising a machine learning and reasoning component that employs a probabilistic and/or statistical-based analysis to prognose or infer an action that a user desires to be automatically performed.

12. A computer-implemented method of generating multi-language natural language datasets for software application development, comprising:
developing training data from within an authoring tool in a first human language as part of a first natural language dataset;
translating a subset of the first natural language dataset into multiple different natural language datasets via a machine translation process; and
employing the multiple different natural language datasets in an application.

13. The method of claim 12, wherein the authoring tool facilitates development of a speech-related application.

14. The method of claim 12, further comprising selecting multiple output languages into which the first natural language dataset is to be translated.

15. The method of claim 14, further comprising automatically performing translating the subset of the first natural language dataset into multiple different natural language datasets in response to selecting the multiple output languages.

16. The method of claim 12, further comprising importing into the training data transcribed data associated with a speech-related application.

17. The method of claim 12, wherein the subset of the natural language dataset is a response container that is translated during translating of the subset.

18. The method of claim 12, wherein translating of the subset selects only example data associated with a response node.

19. The method of claim 12, further comprising tagging an example utterance of a response node for utilization as test data.

20. A computer-executable system for application development, the system comprising:
computer-implemented means for inputting data in a first human language as part of a first natural language training dataset;
computer-implemented means for translating a subset of the first natural language training dataset into datasets of multiple different languages via a machine translation process; and
computer-implemented means for replacing data in the first natural language training dataset with corresponding translated data of one of the datasets of the multiple different languages.
